(19) United States
(12) Patent Application Publication
(10) Pub. No.: US 2025/0056681 A1
(43) Pub. Date: Feb. 13, 2025

(54) Electrical Heating Device

(71) Applicant: Eberspächer catem GmbH & Co., KG, Herxhelm (DE)

(72) Inventors: Kai-Fabian Bürkle, Hinterweidentha (DE); Markus Hoffmann, Beindersheim (DE); Jikang Wang, RÜlzheim (DE); Gaetan Ahoufack, Pirmasens (DE); Timo KrÖner, RÜlzheim (DE); Ralf Lothar Weinand, WÖrth am Rhein (DE); Sascha Herzig, Bad Bergzabern (DE); Ahmad Asafi, Karisruhe (DE); Andreas Bachmann, BÖhl-lgglheim (DE); Fabian Beck, Landau in der pfalz (DE); Carina Bauer, Bellheim (DE)

(21) Appl. No.: 18/789,863

(22) Filed: Jul. 31, 2024

(30) Foreign Application Priority Data
Aug. 10, 2023 (DE) 10 2023 121 446.2

(51) Int. Cl. H05B 3/78

(52) U.S. Cl. CPC H05B 3/78

(57) ABSTRACT

An electrical heating device for heating a liquid medium includes a first heating chamber, a second heating chamber, and an electrical heating assembly which is provided between the first heating chamber and the second heating chamber and which is coupled to the first heating chamber and the second heating chamber in a heat-conducting manner. In order to provide an electrical heating device which can be easily adapted to different heating powers and/or operating voltages, the first heating chamber has a first channel section, and the second heating chamber has a second channel section. The first channel section and/or the second channel section form a flow connection between the two heating chambers which passes through the plane containing the electrical heating assembly and the length of which can be varied in a direction transverse to the plane containing the electrical heating assembly.

### BACKGROUND OF THE INVENTION

### 1. Field of the Invention

The present invention relates to an electrical heating device for heating a liquid medium comprising a first heating chamber and a second heating chamber and an electrical heating assembly provided between the first heating chamber and the second heating chamber and coupled to the first heating chamber and the second heating chamber in a heat-conducting manner.

### 2. Background of Related Art

Such an electrical heating device is known from EP 2 559 573 A1. In this prior art, the electrical heating assembly is located between two heating chambers, which are formed by different housing parts and which also accommodate the electrical heating device between them. On the one hand, the connection between the different housing parts must be fluid-tight in order to seal at least one of the heating chambers. On the other hand, however, layers of the electrical heating assembly, which has PTC elements and contact sheets on both sides, must be reliably abutted against each other in order to achieve good electrical contact and good heat extraction. In the above prior art, one of the heating chambers is covered by a control housing, which accommodates power transistors that are deheated via the corresponding heating chamber. The control housing is adapted as a separate, self-contained component and forms the cover of the corresponding heating chamber. The medium to be heated is passed through one of the heating chambers and then through the other of the heating chambers, flowing parallel to the layers of the electrical heating assembly.

### SUMMARY

The present invention aims to provide an electrical heating device which can be easily adapted to different heating powers and/or operating voltages.

In view of this, the present invention provides an electrical heating device in which the first heating chamber comprises a first channel section and the second heating chamber comprises a second channel section. The first or the second channel section forms a flow connection between the two heating chambers passing through a plane containing the electrical heating assembly. Since the first and second channel sections can also overlap, both channel sections can also be combined to form the flow connection between the two heating chambers passing through the plane containing the electrical heating assembly. According to the invention, the length of the flow connection can be varied in a direction transverse to the plane containing the electrical heating assembly. For this purpose, the respective channel sections can be variable in length individually or as a whole.

The channel sections can be in communication with each other in a telescopic fashion such that the length of the flow connection can be varied. In addition or alternatively, a bellows can be arranged between each channel section assigned to each of the heating chambers. The variable length will allow the two heating chambers to be arranged at varying distance so as to compensate for a certain degree of tolerance exerted by each of the layers of the electrical heating assembly, in particular the layer defined by multiple PTC elements.

With regard to a solution which has the required stability under the operating conditions in a motor vehicle, in which the electrical heating devices according to the present invention are used in particular, it is proposed according to a possible further development of the present invention that the first channel section has a bushing end and that the second channel section has a tip end which dips into the bushing end. A sealing arrangement is provided between the bushing end and the tip end, which is displaceable in at least one of the tip end and the bushing end. Thus, this further development proposes per se rigid configurations of the channel sections, wherein the change in the length of the flow connection is achieved by the sealing arrangement displacing relative to at least one of the tip end and bushing end.

The change in length of the flow channel allows the arrangement of heating devices of different thicknesses and between the first and second heating chambers. These different thicknesses may be required by different configuration parameters, such as heating power, which the electrical heating device is intended to provide in model variants. The electrical heating assembly of the electrical heating device according to the invention may comprises PTC elements, the thickness of which should be varied with the operating voltage applied in order to prevent electrical flashovers. Thus, PTC elements of different thicknesses can be placed between the first and second heating chambers due to the flow connection being variable in length to provide either an electrical heating device for operation at 400 volts or an electrical heating device for operation at 800 volts. In the latter case, all PTC elements between the two heating chambers are thicker than in the case mentioned first.

For example, the electrical heating device according to the present invention can be adapted optionally and without changing the structure as such in model variants for operation with different operating voltages.

An abutment shoulder may assigned to the tip end, which interacts axially and/or radially with the sealing arrangement. The sealing arrangement, which may comprise one or more sealing rings, may be precisely positioned with regard to the axial position at least relative to the tip end by means of this abutment shoulder.

The housing, in particular a housing base part described in more detail below, may be connected to inlet and outlet nozzles. These nozzles can be screwed, riveted, welded, soldered or glued to the housing base part, which is formed as a cast or deep-drawn part, or connected in some other way to form a part. The nozzles are used to connect the electrical heating device to the hoses or tubes carrying the medium to be heated inside the vehicle.

The housing, in particular a housing base part explained in more detail below, may form a first inlet channel section communicating with the inlet nozzle and/or a first outlet channel section communicating with the outlet nozzle. The fluid housing may form a second inlet channel section aligned flush with the first inlet channel section and/or a second outlet channel section aligned flush with the first outlet channel section. The first inlet channel section and the first outlet channel section are assigned to the first heating chamber. The second inlet channel section and the second outlet channel section are assigned to the second heating chamber. The merging inlet or outlet channel sections allow the partial flow introduced into the fluid housing to be transferred with low pressure loss. The nozzles can be aligned flush with the channel sections. Usually, the nozzles and the channel sections provide a flow of the medium at right angles to the layers of the electrical heating device.

The second inlet channel section and/or the first outlet channel section is usually provided downstream of a distributor in the flow direction. The distributor is usually formed by the housing base part. The distributor divides the medium introduced through the inlet into partial flows to the first heating chamber and to the second heating chamber and/or the partial flows coming from the first heating chamber and from the second heating chamber are brought together by the distributor. This distributor is usually located on one side of the fluid housing or on the side of the heating device.

In this configuration, the inlet channel sections form an inlet flow connection passing through the plane containing the electrical heating assembly. A corresponding outlet flow connection passing through the plane containing the electrical heating assembly may be formed by the outlet channel sections.

The housing may consist solely of a housing base part and a housing cover. The housing base part has a housing bottom, which is usually flat and bounds the housing, and which usually extends essentially parallel to the housing cover. These components of the housing are usually made of a metallic material; in any case, the materials have good electromagnetic shielding properties. Housings made of plastic with a shielding device incorporated in or surrounding or shielding the housing, for example formed by a wire mesh, are also possible. An accommodation space, formed by the housing to accommodate all components of the electrical heating device, may be defined solely by the two components, the housing base part and the housing cover.

### BRIEF DESCRIPTION OF THE DRAWINGS

Further details and advantages of the present invention will become apparent from the following description of an embodiment in conjunction with the drawing. Therein it is shown by:

FIG. 1: a perspective exploded view of an embodiment of the present invention;

FIG. 2: a perspective exploded view of the housing base part and the heating chamber cover of the embodiment according to FIG. 1;

FIG. 3: a perspective exploded view of the fluid housing of the embodiment according to FIG. 1;

FIG. 4: a perspective top view of the housing base part partially equipped with components of the embodiment according to FIG. 1 and

FIG. 5: a sectional view of the first embodiment along the line V-V drawn in FIG. 4.

### DETAILED DESCRIPTION

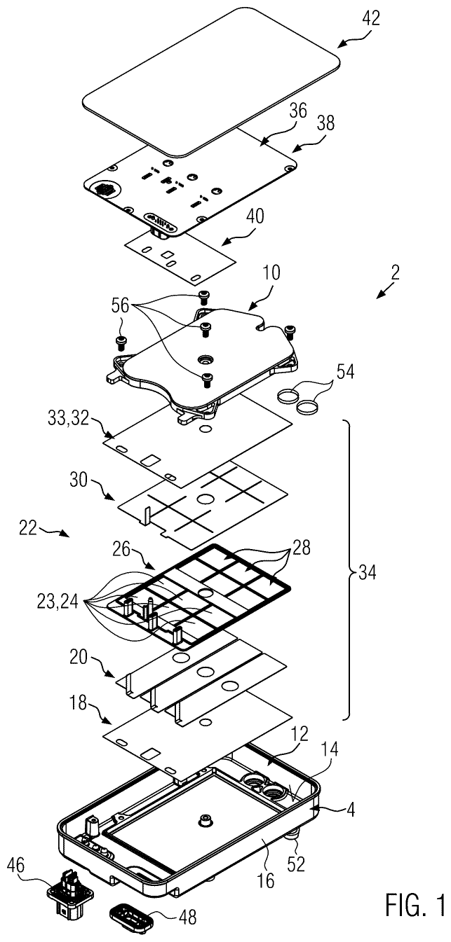

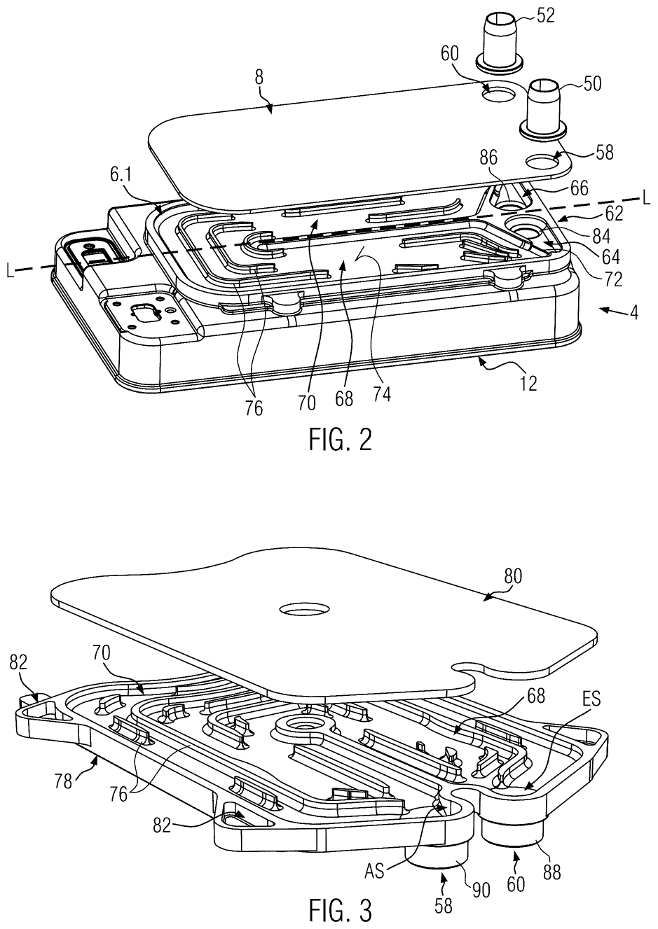

FIG. 1 shows an electrical heating device 2 with a housing base part 4, which is connected to a heating chamber cover 8 on its lower side in FIG. 1 to form a first heating chamber 6.1—see FIG. 2. Reference sign 10 characterizes a fluid housing, which is accommodated in an accommodation space 12 formed by the housing base part 4. In this accommodation space 12, which is bounded on the lower side by a bottom 14 and on the peripheral sides by a circumferential wall 16 extending from the bottom 14, and between the bottom 14 and the fluid housing 10, there is a first insulating layer 18, which can be abutted against the bottom 14, a first contacting layer 20 and a heating assembly 22 with a plurality of heating elements 23, in the present case in the form of PTC elements 24, and a positioning frame 26 with accommodations 28 for accommodating the PTC elements 24.

On the side opposite the first contacting layer 20 of the heating assembly 22, a second contacting layer 30 is provided, on the side of which opposite the heating assembly 22 a second insulating layer 32 is arranged. The PTC elements are therefore applied electrically conductive against the contacting layers 20, 30 and are energized via the same. The PTC elements 24 are ceramic cuboid components, which are provided with a metallization on opposite main side surfaces for current conduction. The main side surface is the surface of the cuboid with the largest surface area. The main side surfaces are connected to each other by peripheral surfaces that define the height of the PTC elements and have no metallization. The main side surfaces are generally each larger by a factor of 5 than one of the peripheral surfaces, possibly than the sum of all the peripheral surfaces.

The second insulating layer 32 is formed as a biasing device 33 by a silicone film, which is capable of absorbing certain compressions by elastic deformation and thus arranging the electrical heating assembly 22 between the housing base part 10 and the housing bottom 14 and bias the same against the housing base part 10 and the housing bottom 14.

The layering of the first insulating layer 18, the first contacting layer 20, the heating de-vice 21, the second contacting layer 30 and the second insulating layer 32 is hereinafter also referred to as a layered structure 34.

On the side of the fluid housing 10 facing away from this layered structure 34, in the embodiment shown, a transistor insulation 40 is located between a printed circuit board 38 forming a control device 36 and the fluid housing 10. Reference sign 42 characterizes a housing cover which is connected to the housing base part 4 to form a housing characterized by reference sign 44 in FIG. 5. The housing base part 4 and the housing cover 42, possibly further housing parts, are configured to be shielding, that is, made of metal and/or provided with a separate shielding inside, outside or in the walls of the respective housing part, which are conceivably made of plastic. A suitable metallic material is aluminum or, with a view to corrosion resistance, stainless steel.

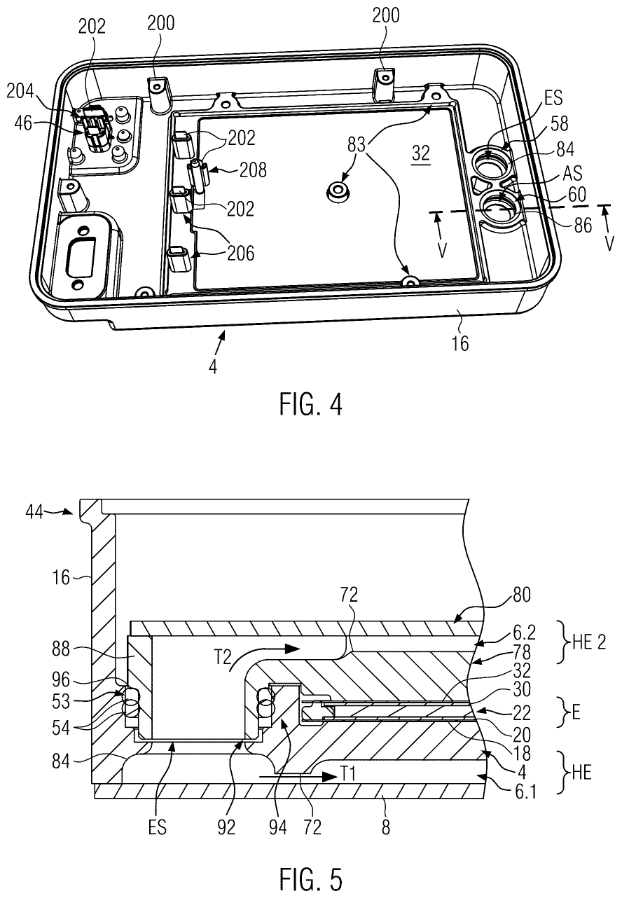

A power connector 46 and a control connector 48 are shown in FIG. 1 on the lower side of the housing base part 4 opposite this housing cover 42. These two connectors 46, 48 are connected to the housing base part 4 in a sealed manner and have various male electrical plug contacts which are led through the respective housings of the connectors 46, 48 in a sealed manner and are plug-contacted in the printed circuit board 38 and are electrically connected to strip conductors of the printed circuit board 38 via this plug contacting. Details of this are described below in conjunction with FIG. 4. For the plug contacting, the printed circuit board 38 has female contact tongue receptacles, which are described in EP 2 236 330 A1.

Furthermore, inlet and outlet nozzles 50, 52 are provided on the lower side for the connection of pipes or hoses which carry the fluid to be heated. Reference sign 53 characterizes the seal arrangement shown in FIG. 1 below the fluid housing 10, which in the present case is formed by two sealing rings 54, which are explained in more detail below. Reference sign 56 characterizes screws for fixing the fluid housing 10 opposite the housing base part 4 with interposition of the layered structure 34. Through this screw connection, the layers of the layered structure 34 are biased against the fluid housing 10 and the bottom 14 of the housing base part 4.

FIG. 2 shows an exploded view of the housing base part 4 and the heating chamber cover 8, which is shown spaced apart therefrom, and reveals the interior of the first heating chamber 6.1. It can be seen that the nozzles 50, 52 are formed by separate components which are flush with two bores within the heating chamber cover 8 formed from a flat sheet metal, one of which bores forms an inlet 58 and the other an outlet 60. The nozzles 50, 52 may be welded or bonded to the heating chamber cover 8.

Reference sign 62 characterizes a distributor arranged in a plane HE containing the first heating chamber 6.1. The distributor 62 has an inlet distributor section 64 and an outlet distributor section 66, which are each provided separately from each other and covered by the heating chamber cover 8. The respective distributor sections 64, 66 are provided symmetrically with respect to a longitudinal axis L of the housing base part 4 and are associated with an inlet branch 68 and an outlet branch 70 of the first heating chamber 6.1, respectively. In the top view, the distributor sections 64, 66 each have an approximately triangular ground area. Each distributor section 64, 66 merges into the respective branch 68, 70 via an overflow edge 72. The overflow edge 72 lies in the height direction between a first heating chamber bottom 74 of the first heating chamber 6.1 and an opposite cover surface of the first heating chamber 6.1 formed by the heating chamber cover 8.

Flow guide ribs 76 project from this first heating chamber bottom 74 to guide the flow, against which the heating chamber cover 8 abuts in a fluid-tight manner.

The inlet 58 or the outlet 60 in each case is arranged such that it partially covers the first heating chamber 6.1 and partially covers the respective distributor section 64, 66. The overflow edge 72 passes approximately centrally through the bore forming the inlet 58 or the outlet 60.

Details of the second heating chamber 6.2 can be seen in FIG. 3. The fluid housing 10 is formed by a fluid housing base part 78 and a fluid housing cover 80 welded thereto. The second heating chamber 6.2 also comprises flow guide ribs 76. A plurality of fastening eyes 82 are provided on the circumference of the fluid housing 10, through which the screws 56 are guided in order to connect the fluid housing 10 to the housing bottom 14 with the electrical heating assembly 22 interposed. In FIG. 4, threads formed on the housing bottom 14 are characterized by reference sign 83.

In FIG. 4, reference sign 84 characterizes a first inlet channel section and reference sign 86 characterizes a first outlet channel section. These channel sections 84, 86 are formed on and through the housing base part 4. FIG. 3 shows second inlet and outlet channel sections 88, 90 formed integrally on the fluid housing base part 78.

As conveyed in particular by FIG. 5, the second channel sections 88, 90 are formed as tip ends 92, each engaging a bushing end 94 formed by the first channel sections 84, 86, wherein the seal arrangement 53 is provided therebetween and abuts in an axial and radial direction against an abutment shoulder 96 provided on the respective tip end 92.

The tip end 92 and the bushing end 94 have an axial length such that electrical heating assemblies 22 having different thicknesses can be arranged between the fluid housing 10 and the housing bottom 14, without loss of sealing between the housing base part 4 and the fluid housing 10. As a result, an inlet flow connection ES formed by the inlet channel sections 84, 86 is variable in length transverse to the plane E containing the electrical heating assembly 22. The same applies to an outlet flow connection characterized by reference sign AS.

The fluid flow introduced into the electrical heating device 2 through the inlet 58 is divided into two partial flows in the area of the distributor 62. The first partial flow T1 flows via the overflow edge 72 into the first heating chamber 6.1 whereas the second partial flow T2 passes through the inlet flow connection ES, flows through the second heating chamber 6.2, first through the inlet branch 68 and then through the outlet branch 70, and finally through the outlet flow connection AS, is brought together with the first partial flow T1 in the area of the distributor 62 and the fluid flow resulting from the combination of these two partial flows T1, T2 is discharged through the outlet.

FIG. 4 also conveys the electrical connection concept for the printed circuit board 38. Contact tongues 202 of male plug contacts 204, which are exposed at the free ends of the connectors (only the power connector 46 is shown) or at the free ends of terminal lugs 206 of the minus contacts or at the free ends of terminal lugs 208 of the plus contact, protrude into a mounting plane of the printed circuit board 38, which is recognizable by supports 200 for the printed circuit board 38. The terminal lugs 206, 208 also protrude beyond the fluid housing 10 after assembly, which is arranged below the mounting plane of the printed circuit board 38. The printed circuit board 38 can be plug-contacted with all contact tongues 202 by simply lowering it in the direction of the housing bottom 14, that is, in a direction orthogonal to the flat extension of the housing bottom 14. The mounted printed circuit board 38 rests on the supports 200 and is fixed against the housing base part 4 by means of screws, not shown, which are engaged in threads of the supports 200.

The solution described here offers the following advantages:
1. Since the electrical heating assembly 22 can provided within the metallic housing 44, this results in good EMC shielding.
2. Since a heating chamber 6.1; 6.2 is provided on each side of the electrical heating assembly 22, heat is emitted to the medium to be heated on both main sides of the electrical heating assembly 22.
3. Since the medium to be heated is divided into partial flows T1, T2, the same heating conditions prevail on both sides of the electrical heating assembly 22. This also applies to the respective branches 68, 70. Thus, the PTC elements 24 provided distributed relative to the housing bottom 14 are each located between the heat dissipating surfaces provided by the first or second heating chamber 6.1; 6.2, which apply the same temperature gradient to the respective PTC elements 24.
4. All housing parts can be made of aluminum or an aluminum alloy and thus save weight.
5. All housing parts 4, 20; 78, 80 bounding the respective heating chamber 6.1 6.2 can be welded together directly and in a fluid-tight manner, which results in a high degree of reliability with regard to sealing.
6. Moreover, heating chambers 6.1; 6.2 can be tested for tightness after joining the housing parts 4, 20; 78, 80 forming the heating chambers 6.1; 6.2 and before final assembly of the electrical heating device 2.
7. Since the flow connections ES and AS for the inlet or outlet of the medium are variable in length, electrical heating assemblies 22 of different thickness and thus different performance can be installed without having to change the housing parts 4, 20; 78, 80 defining the first or second heating chamber 6.1, 6.2.
8. The distributor 62 enables the same partial flows T1, T2 to be divided with the same volume flow with low differential pressure loss.
9. The inlet and outlet nozzles 50; 52 can be connected to the housing base part 4 as separate components, so that these interfaces can be adapted for the connection of tubes or lines according to customer requirements without having to change the components defining the first or second heating chamber 6.1, 6.2.

1. An electrical heating device for heating a liquid medium, comprising:
a first heating chamber;
a second heating chamber; and
an electrical heating assembly which is provided between the first heating chamber and the second heating chamber and which is coupled to the first heating chamber and the second heating chamber in a heat-conducting manner, wherein
the first heating chamber has a first channel section, and the second heating chamber has a second channel section, wherein
at least one of the first channel section and second channel section forms a flow connection between the first and second heating chambers, wherein
the flow connection passes through a plane containing the electrical heating assembly and has a length which can be varied in a direction transverse to the plane containing the electrical heating assembly.

2. The electrical heating device according to claim 1, wherein the first channel section has a bushing end, wherein the second channel section has a tip end which dips into the bushing end, and wherein a sealing arrangement is provided between the bushing end and the tip end, which sealing arrangement is displaceable at least towards one of the tip end and the bushing end.

3. The electrical heating device according to claim 2, wherein an abutment shoulder is assigned to the tip end, the abutment shoulder interacting axially and/or radially with the sealing arrangement.

4. The electrical heating device according to claim 1, wherein a first inlet channel section and a first outlet channel section are assigned to the first heating chamber, wherein a second inlet channel section and a second outlet channel section are assigned to the second heating chamber, wherein the first and second inlet channel sections form an inlet flow connection between the first and second heating chambers which passes through a plane containing the electrical heating assembly and the length of which can be varied in a direction transverse to the plane containing the electrical heating assembly, and wherein the first and second outlet channel sections form an outlet flow connection between the first and second heating chambers which passes through the plane containing the electrical heating assembly and the length of which can be varied in a direction transverse to the plane containing the electrical heating assembly.

5. The electrical heating device according to claim 1, wherein the first heating chamber is formed between 1) a housing bottom of a housing base part forming an inlet and an outlet for the medium and 2) a heating chamber cover, and wherein the second heating chamber is formed by a fluid housing arranged inside the housing base part.

6. The electrical heating device according to claim 5, wherein the housing base part forms a distributor via which the medium introduced through the inlet is divided into partial flows to the first heating chamber and to the second heating chamber and via which partial flows coming from the first heating chamber and from the second heating chamber are brought together.

7. The electrical heating device according to claim 1, further comprising a housing which forms an inlet and an outlet for the medium and which has a housing cover, wherein an accommodation space is defined by the housing base part and the housing cover, and wherein the heating assembly and a fluid housing forming the second heating chamber are accommodated in the accommodation space.

8. The electrical heating device according to claim 7, wherein the first heating chamber is formed between a housing bottom of the housing base part and a heating chamber cover that is connected to the housing bottom in a fluid-tight manner, and wherein the second heating chamber is formed by a fluid housing which is accommodated in the housing.
